(19) United States
(12) Patent Application Publication
(10) Pub. No.: US 2026/0221339 A1
(43) Pub. Date: Jul. 30, 2026

(54) MULTILAYER CAPACITOR

(71) Applicant: TDK Corporation, Tokyo (JP)

(72) Inventors: Toru ONOUE, Tokyo (JP); Masahiro IWAMA, Tokyo (JP)

(73) Assignee: TDK Corporation, Tokyo (JP)

(21) Appl. No.: 19/417,655

(22) Filed: Dec. 12, 2025

(30) Foreign Application Priority Data
Jan. 29, 2025 (JP) 2025-012925

(51) Int. Cl. H01G 4/005; H01G 4/232; H01G 4/248; H01G 4/30

(52) U.S. Cl. CPC H01G 4/005; H01G 4/232; H01G 4/248; H01G 4/30

(57) ABSTRACT

A multilayer capacitor includes an element body, and first, second, and third internal electrodes arranged within the element body. The first and second internal electrodes are arranged to form a first capacitance. The first and third internal electrodes are arranged to form a second capacitance. The second and third internal electrodes are arranged to form a third capacitance. The first capacitance is larger than the second and third capacitances. To reduce variation in the smaller second and third capacitances, each third internal electrode has a specific dimensional constraint. Each third internal electrode has at least one of a width smaller than the widths of the first and second internal electrodes, and a length smaller than an opposing length between the first and second internal electrodes.

### CROSS-REFERENCE TO RELATED APPLICATIONS

This application is based upon and claims the benefit of priority from Japanese Patent Application No. 2025-012925, filed on January 29, 2025, the entire contents of which are incorporated herein by reference.

### BACKGROUND

### Field

One aspect of the present disclosure relates to a multilayer capacitor.

### Description of the Related Art

A known multilayer capacitor includes an element body, a plurality of internal electrodes disposed in the element body, and a plurality of external electrodes disposed on the element body (for example, refer to Japanese Unexamined Patent Application Publication No. 2006-147792). Each of the plurality of internal electrodes is connected to a corresponding external electrode among the plurality of external electrodes.

### SUMMARY

One aspect of the present disclosure provides a multilayer capacitor that can accommodate a wider range of variations in the relative position of a plurality of internal electrodes.

A multilayer capacitor according to one aspect of the present disclosure includes an element body, a plurality of external electrodes, and a plurality of internal electrodes. The element body includes a first end surface and a second end surface opposing each other in a first direction, and a pair of side surfaces opposing each other in a second direction intersecting the first direction. The plurality of external electrodes include a first external electrode disposed on the first end surface, a second external electrode disposed on the second end surface, and a third external electrode disposed on one of the pair of side surfaces. The plurality of internal electrodes are arranged in the element body to oppose each other in a third direction intersecting the first direction and the second direction. The plurality of internal electrodes include a plurality of first internal electrodes, a plurality of second internal electrodes, and a plurality of third internal electrodes. The plurality of first internal electrodes each include a first connection end connected to the first external electrode, and a first end opposing the second end surface. The plurality of second internal electrodes each include a second connection end connected to the second external electrode, and a second end opposing the first end surface. The plurality of third internal electrodes each include a third connection end connected to the third external electrode, a third end opposing the one of the pair of side surfaces, and a fourth end opposing the other of the pair of side surfaces. Each of the first internal electrodes has a first width that is a maximum width in the second direction. Each of the second internal electrodes has a second width that is a maximum width in the second direction. Each of the third internal electrodes has a third width that is a maximum width between the third end and the fourth end in the second direction, and a fourth width that is a maximum width in the first direction. Each of the third internal electrodes satisfies at least one of: a condition in which the third width is smaller than both the first width and the second width; or a condition in which the fourth width is smaller than a distance between the first end and the second end in the first direction. The plurality of first internal electrodes and the plurality of second internal electrodes are arranged to provide a first capacitance. The plurality of first internal electrodes and the plurality of third internal electrodes are arranged to provide a second capacitance smaller than the first capacitance. The plurality of second internal electrodes and the plurality of third internal electrodes are arranged to provide a third capacitance smaller than the first capacitance.

### BRIEF DESCRIPTION OF THE DRAWINGS

FIG. 1 is a perspective view of a multilayer capacitor according to an embodiment;

FIG. 2 is a diagram illustrating a cross-sectional configuration of the multilayer capacitor according to the embodiment;

FIG. 3 is a diagram illustrating another cross-sectional configuration of the multilayer capacitor according to the embodiment;

FIG. 4 is a plan view of a first internal electrode of the embodiment;

FIG. 5 is a plan view of a third internal electrode of the embodiment;

FIG. 6 is a plan view of a second internal electrode of the embodiment; and

FIG. 7 is a table illustrating a relationship between a ratio of a third electrode area to a first electrode area and a second electrode area, and capacitance.

### DETAILED DESCRIPTION

Hereinafter, examples of the present disclosure will be described in detail with reference to the accompanying drawings. In the following description, the same elements or elements having the same functions are denoted with the same reference numerals and overlapped explanation is omitted.

The present inventors have recognized the following findings.

In a multilayer capacitor, a plurality of internal electrodes opposing each other form a capacitance. A change in the positional relationship between the plurality of internal electrodes causes a change in their opposing area, thereby altering the capacitance formed by the opposing electrodes. A multilayer capacitor including three or more external electrodes connected to the plurality of internal electrodes has three or more rated capacitances corresponding to the three or more external electrodes. Among the three or more rated capacitances, if a relative position of a plurality of internal electrodes corresponding to one rated capacitance with a relatively small capacitance varies, the effect on the capacitance is particularly large.

Based on the above-described findings, the present inventors have conceived the following aspect.

One aspect of the present disclosure relates a multilayer capacitor that includes an element body, a plurality of external electrodes, and a plurality of internal electrodes. The element body includes a first end surface and a second end surface opposing each other in a first direction, and a pair of side surfaces opposing each other in a second direction intersecting the first direction. The plurality of external electrodes include a first external electrode disposed on the first end surface, a second external electrode disposed on the second end surface, and a third external electrode disposed on one of the pair of side surfaces. The plurality of internal electrodes are arranged in the element body to oppose each other in a third direction intersecting the first direction and the second direction. The plurality of internal electrodes include a plurality of first internal electrodes, a plurality of second internal electrodes, and a plurality of third internal electrodes. The plurality of first internal electrodes each include a first connection end connected to the first external electrode, and a first end opposing the second end surface. The plurality of second internal electrodes each include a second connection end connected to the second external electrode, and a second end opposing the first end surface. The plurality of third internal electrodes each include a third connection end connected to the third external electrode, a third end opposing the one of the pair of side surfaces, and a fourth end opposing the other of the pair of side surfaces. Each of the first internal electrodes has a first width that is a maximum width in the second direction. Each of the second internal electrodes has a second width that is a maximum width in the second direction. Each of the third internal electrodes has a third width that is a maximum width between the third end and the fourth end in the second direction, and a fourth width that is a maximum width in the first direction. Each of the third internal electrodes satisfies at least one of: a condition in which the third width is smaller than both the first width and the second width; or a condition in which the fourth width is smaller than a distance between the first end and the second end in the first direction. The plurality of first internal electrodes and the plurality of second internal electrodes are arranged to provide a first capacitance. The plurality of first internal electrodes and the plurality of third internal electrodes are arranged to provide a second capacitance smaller than the first capacitance. The plurality of second internal electrodes and the plurality of third internal electrodes are arranged to provide a third capacitance smaller than the first capacitance.

The plurality of third internal electrodes form the second capacitance with the plurality of first internal electrodes and form the third capacitance with the plurality of second internal electrodes. Each of the second capacitance and the third capacitance is relatively smaller than the first capacitance between the plurality of first internal electrodes and the plurality of second internal electrodes.

Each of the third internal electrodes includes at least one of the third width, which is smaller than both the first width and the second width, and the fourth width, which is smaller than the distance in the first direction between the first end and the second end.

For example, when the third internal electrode includes the third width, which is smaller than both the first width and the second width, even if the relative positions of the plurality of third internal electrodes, the plurality of first internal electrodes, and the plurality of second internal electrodes vary in the second direction, the second capacitance or the third capacitance is unlikely to vary as long as the variation is within a range that does not alter an opposing area between the third internal electrode and the first internal electrode or between the third internal electrode and the second internal electrode.

For example, when the third internal electrode includes the fourth width, which is smaller than the distance in the first direction between the first end and the second end, even if the relative positions of the plurality of third internal electrodes, the plurality of first internal electrodes, and the plurality of second internal electrodes vary in the first direction, the second capacitance or the third capacitance is unlikely to vary as long as the variation is within a range that does not alter an opposing area between the third internal electrode and the first internal electrode or between the third internal electrode and the second internal electrode.

Therefore, the one aspect can accommodate a wider range of variations in the relative position of the plurality of internal electrodes.

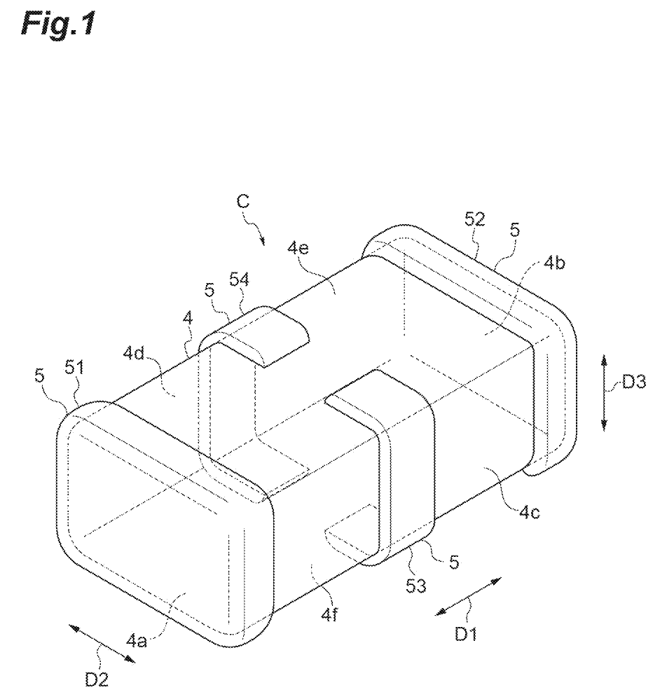

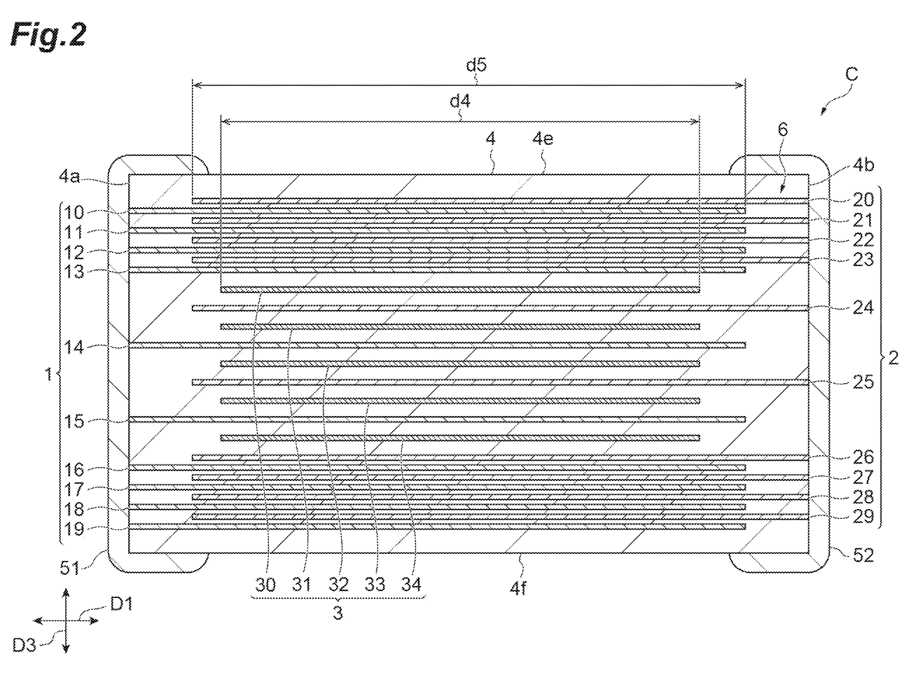

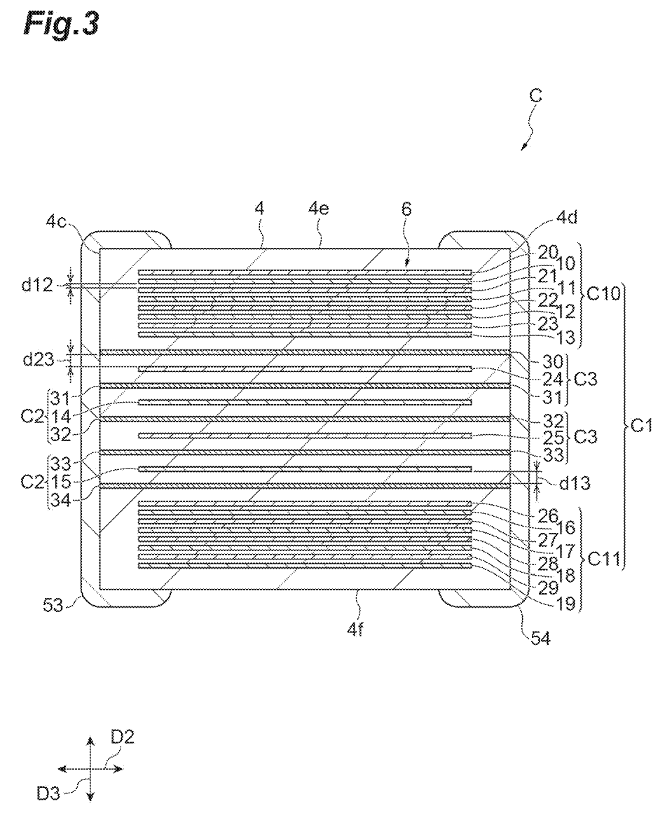

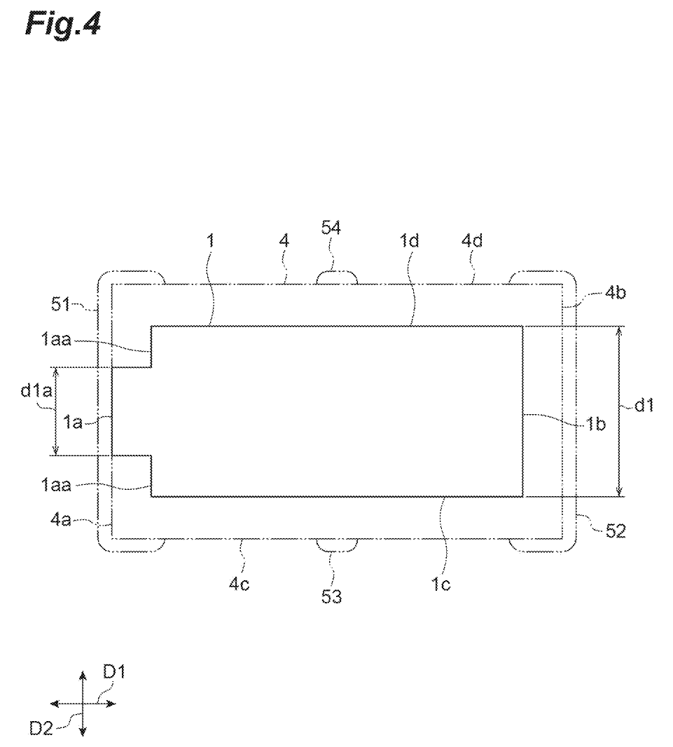

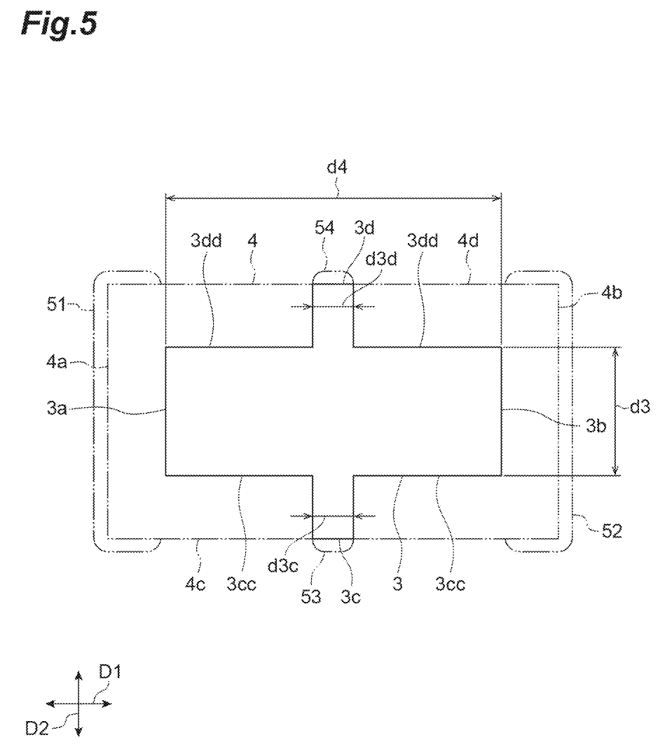

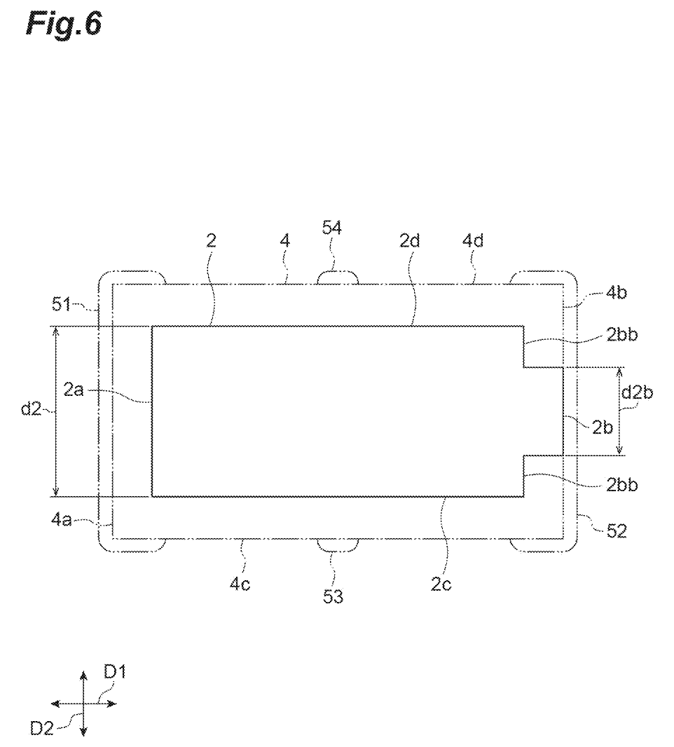

A configuration of a multilayer capacitor C according to the present embodiment will be described with reference to FIGS. 1 to 6. FIG. 1 is a perspective view of a multilayer capacitor according to an embodiment. FIG. 2 is a diagram illustrating a cross-sectional configuration of the multilayer capacitor according to the embodiment. FIG. 3 is a diagram illustrating another cross-sectional configuration of the multilayer capacitor according to the embodiment. FIG. 4 is a plan view of a first internal electrode of the embodiment. FIG. 5 is a plan view of a third internal electrode of the embodiment. FIG. 6 is a plan view of a second internal electrode of the embodiment. The multilayer capacitor C according to the present embodiment is solder-mounted on an electronic device. The electronic device includes, for example, a circuit board or an electronic component. As illustrated in FIGS. 1 to 6, the multilayer capacitor C includes an element body 4, a plurality of external electrodes 5, and a plurality of internal electrodes 6.

The element body 4 has a rectangular parallelepiped shape. The rectangular parallelepiped shape includes a rectangular parallelepiped shape in which corners and ridges are chamfered and rounded. The element body 4 includes an end surface 4a and an end surface 4b opposing each other, a side surface 4c and a side surface 4d opposing each other, and a main surface 4e and a main surface 4f opposing each other. The end surfaces 4a, 4b, the side surfaces 4c, 4d, and the main surfaces 4e, 4f each have a rectangular shape. The side surfaces 4c, 4d and the main surfaces 4e, 4f connect the end surface 4a and the end surface 4b. The end surfaces 4a and 4b, and the side surfaces 4c, 4d and the main surfaces 4e, 4f are adjacent to each other via corners or ridges. When the multilayer capacitor C is solder-mounted on an electronic device, the main surface 4e or the main surface 4f opposes the electronic device on which the multilayer capacitor C is solder-mounted.

The end surface 4a and the end surface 4b oppose each other in a direction D1. For example, the end surface 4a includes a first end surface, the end surface 4b includes a second end surface, and the direction D1 includes a first direction. The side surface 4c and the side surface 4d oppose each other in a direction D2. The direction D2 intersects the direction D1. For example, the side surface 4c and the side surface 4d include a pair of side surfaces, and the direction D2 includes a second direction. The main surface 4e and the main surface 4f oppose each other in a direction D3. For example, the main surface 4e includes a first main surface, and the main surface 4f includes a second main surface. The direction D3 intersects the direction D1 and the direction D2. In the present embodiment, the direction D1, the direction D2, and the direction D3 are orthogonal to each other. In one example, a length of the element body 4 in the direction D1 is larger than a length of the element body 4 in the direction D2 and larger than a length of the element body 4 in the direction D3. In one example, the length of the element body 4 in the direction D2 is larger than the length of the element body 4 in the direction D3.

The element body 4 is formed by laminating a plurality of dielectric layers along the direction D3. The element body 4 includes the plurality of laminated dielectric layers. In the element body 4, a lamination direction of the plurality of dielectric layers includes the direction D3. Each dielectric layer includes, for example, a sintered body of a ceramic green sheet including a dielectric material. The dielectric material includes, for example, a dielectric ceramic such as BaTiO₃-based, Ba(Ti, Zr)O₃-based, or (Ba, Ca)TiO₃-based. In an actual element body 4, the dielectric layers are integrated to an extent that boundaries between the dielectric layers are not visible.

The plurality of external electrodes 5 include an external electrode 51, an external electrode 52, and an external electrode 53. In the present embodiment, the plurality of external electrodes 5 include an external electrode 54. The external electrode 51 is disposed on the end surface 4a. The external electrode 52 is disposed on the end surface 4b. The external electrode 53 is disposed on one side surface 4c of the side surfaces 4c and 4d. The external electrode 54 is disposed on the other side surface 4d of the side surfaces 4c and 4d. For example, the external electrode 51 includes a first external electrode, the external electrode 52 includes a second external electrode, the external electrode 53 includes a third external electrode, and the external electrode 54 includes a fourth external electrode. On a surface of the element body 4, the external electrodes 51, 52, 53, and 54 are disposed apart from each other.

In one example, the external electrode 51 is disposed on an entire surface of the end surface 4a, ends of the side surfaces 4c and 4d adjacent to the end surface 4a, and ends of the main surfaces 4e and 4f adjacent to the end surface 4a. In one example, the external electrode 52 is disposed on an entire surface of the end surface 4b, ends of the side surfaces 4c and 4d adjacent to the end surface 4b, and ends of the main surfaces 4e and 4f adjacent to the end surface 4b.

In one example, the external electrode 53 is disposed on a part of the side surface 4c, an end of the main surface 4e adjacent to the part of the side surface 4c, and an end of the main surface 4f adjacent to the part of the side surface 4c. In one example, the external electrode 54 is disposed on a part of the side surface 4d, an end of the main surface 4e adjacent to the part of the side surface 4d, and an end of the main surface 4f adjacent to the part of the side surface 4d. On the surface of the element body 4, the external electrodes 53 and 54 are disposed between the external electrode 51 and the external electrode 52. In one example, a width of the external electrodes 53 and 54 in the direction D1 is not more than half of a distance between the external electrode 51 and the external electrode 52.

Each external electrode 5 includes a conductive material. The conductive material includes, for example, Ag, Pd, Cu, Ni, or Al. The conductive material includes, for example, an Ag-Pd alloy, an Ag-Cu alloy, an Ag-Au alloy, or an Ag-Pt alloy. Each external electrode 5 may include a plating film formed on the conductive material fixed on the surface of the element body 4. Each external electrode 5 includes, for example, a Ni plating film, a Sn plating film, a Cu plating film, or an Au plating film. Each external electrode 5 may have a multilayer structure of the above-described plating films, and may include a Ni plating film and a Sn plating film formed on the Ni plating film. The plating film is formed by, for example, an electrolytic plating method or an electroless plating method.

The plurality of internal electrodes 6 are arranged in the element body 4 to oppose each other in the direction D3. For example, the direction D3 includes a third direction. The plurality of internal electrodes 6 have a plurality of internal electrodes 1, a plurality of internal electrodes 2, and a plurality of internal electrodes 3. The plurality of internal electrodes 1 are electrically connected to the external electrode 51. The plurality of internal electrodes 2 are electrically connected to the external electrode 52. The plurality of internal electrodes 3 are electrically connected to the external electrode 53. In the present embodiment, the plurality of internal electrodes 3 are electrically connected to the external electrode 53 and the external electrode 54. For example, the plurality of internal electrodes 1 include a plurality of first internal electrodes, the plurality of internal electrodes 2 include a plurality of second internal electrodes, and the plurality of internal electrodes 3 include a plurality of third internal electrodes.

In one example, the plurality of internal electrodes 1 include internal electrodes 10, 11, 12, 13, 14, 15, 16, 17, 18, and 19. The number of the plurality of internal electrodes 1 is "10". Hereinafter, any one or each of the internal electrodes 10, 11, 12, 13, 14, 15, 16, 17, 18, and 19 may be referred to as an "internal electrode 1". In one example, the plurality of internal electrodes 2 include internal electrodes 20, 21, 22, 23, 24, 25, 26, 27, 28, and 29. The number of the plurality of internal electrodes 2 is "10". Hereinafter, any one or each of the internal electrodes 20, 21, 22, 23, 24, 25, 26, 27, 28, and 29 may be referred to as an "internal electrode 2". In one example, the plurality of internal electrodes 3 include internal electrodes 30, 31, 32, 33, and 34.

The number of the plurality of internal electrodes 3 is "5". Hereinafter, any one or each of the internal electrodes 30, 31, 32, 33, and 34 may be referred to as an "internal electrode 3".

In the present embodiment, a number of the plurality of internal electrodes 3 is smaller than a number of the plurality of internal electrodes 1 and is smaller than a number of the plurality of internal electrodes 2. The number of the plurality of internal electrodes 3 may be not more than half of the number of the plurality of internal electrodes 1 and not more than half of the number of the plurality of internal electrodes 2. The number of the plurality of internal electrodes 3 may be not more than 1/4 of the number of the plurality of internal electrodes 1 and not more than 1/4 of the number of the plurality of internal electrodes 2. In the present embodiment, the number of the internal electrodes 1 and the number of the internal electrodes 2 are equal.

In the present embodiment, the plurality of internal electrodes 6 include a plurality of capacitance portions C1, a plurality of capacitance portions C2, and a plurality of capacitance portions C3. The plurality of capacitance portions C1 are configured by the internal electrodes 1 and the internal electrodes 2 adjacent to each other among the plurality of internal electrodes 1 and the plurality of internal electrodes 2. The plurality of capacitance portions C2 are configured by the internal electrodes 1 and the internal electrodes 3 adjacent to each other among the plurality of internal electrodes 1 and the plurality of internal electrodes 3. The plurality of capacitance portions C3 are configured by the internal electrodes 2 and the internal electrodes 3 adjacent to each other among the plurality of internal electrodes 2 and the plurality of internal electrodes 3.

For example, the plurality of capacitance portions C1 include a plurality of first capacitance portions. For example, the plurality of capacitance portions C2 include a plurality of second capacitance portions. For example, the plurality of capacitance portions C3 include a plurality of third capacitance portions.

The plurality of capacitance portions C1 include at least one capacitance portion C10 and at least one capacitance portion C11. The at least one capacitance portion C10 is closest to the main surface 4e among the plurality of capacitance portions C1. The at least one capacitance portion C10 is closer to the main surface 4e than the plurality of capacitance portions C2 and the plurality of capacitance portions C3. The at least one capacitance portion C11 is closest to the main surface 4f among the plurality of capacitance portions C1. The at least one capacitance portion C11 is closer to the main surface 4f than the plurality of capacitance portions C2 and the plurality of capacitance portions C3. For example, the at least one capacitance portion C10 includes at least one first capacitance portion, and the at least one capacitance portion C11 includes at least one other first capacitance portion.

In the present embodiment, the at least one capacitance portion C10 includes a plurality of capacitance portions C10 configured by the internal electrodes 10, 11, 12, 13 and the internal electrodes 20, 21, 22, 23, which are alternately arranged to be adjacent to each other in the order of the internal electrodes 20, 10, 21, 11, 22, 12, 23, 13 from the side closer to the main surface 4e. The plurality of capacitance portions C10 are closer to the main surface 4e than the plurality of capacitance portions C2 and the plurality of capacitance portions C3. The internal electrode 20 is closest to the main surface 4e among the plurality of internal electrodes 6. For example, the internal electrode 20 and the internal electrode 10 constitute one capacitance portion C1 closest to the main surface 4e among the plurality of capacitance portions C1.

In the present embodiment, the at least one capacitance portion C11 includes a plurality of capacitance portions C11 configured by the internal electrodes 16, 17, 18, 19 and the internal electrodes 26, 27, 28, 29, which are alternately arranged to be adjacent to each other in the order of the internal electrodes 19, 29, 18, 28, 17, 27, 16, 26 from the side closer to the main surface 4f. The plurality of capacitance portions C11 are closer to the main surface 4f than the plurality of capacitance portions C2 and the plurality of capacitance portions C3. The internal electrode 19 is closest to the main surface 4f among the plurality of internal electrodes 6. For example, the internal electrode 19 and the internal electrode 29 constitute one capacitance portion C1 closest to the main surface 4f among the plurality of capacitance portions C1. A distance between the internal electrode 19 and the main surface 4f may be equal to a distance between the internal electrode 20 and the main surface 4e.

In the present embodiment, in the direction D3, the plurality of capacitance portions C2 and the plurality of capacitance portions C3 are disposed between the plurality of capacitance portions C1. For example, the plurality of capacitance portions C2 and the plurality of capacitance portions C3 are disposed between the plurality of capacitance portions C10 and the plurality of capacitance portions C11.

In one example, the plurality of internal electrodes 6 are arranged between the plurality of capacitance portions C10 and the plurality of capacitance portions C11 to be adjacent to each other in the order of the internal electrodes 30, 24, 31, 14, 32, 25, 33, 15, 34 from the side closer to the main surface 4e.

The plurality of capacitance portions C2 include, among the plurality of internal electrodes 30, 24, 31, 14, 32, 25, 33, 15, 34, a pair of capacitance portions C2 configured by the internal electrodes 31, 32 and the internal electrode 14 and adjacent to each other in the direction D3, and a pair of capacitance portions C2 configured by the internal electrodes 33, 34 and the internal electrode 15 and adjacent to each other in the direction D3.

For example, the pair of capacitance portions C2 configured by the internal electrodes 31, 32 and the internal electrode 14 include a pair of second capacitance portions adjacent to each other, and the pair of capacitance portions C2 configured by the internal electrodes 33, 34 and the internal electrode 15 include another pair of second capacitance portions adjacent to each other.

The plurality of capacitance portions C3 include, among the plurality of internal electrodes 30, 24, 31, 14, 32, 25, 33, 15, 34, another pair of capacitance portions C3 configured by the internal electrodes 30, 31 and the internal electrode 24 and adjacent to each other in the direction D3, and a pair of capacitance portions C3 configured by the internal electrodes 32, 33 and the internal electrode 25 and adjacent to each other in the direction D3.

For example, the pair of capacitance portions C3 configured by the internal electrodes 32, 33 and the internal electrode 25 include a pair of third capacitance portions adjacent to each other, and the pair of capacitance portions C3 configured by the internal electrodes 30, 31 and the internal electrode 24 include another pair of third capacitance portions adjacent to each other.

The pair of capacitance portions C2 configured by the internal electrodes 31, 32 and the internal electrode 14 and the pair of capacitance portions C3 configured by the internal electrodes 32, 33 and the internal electrode 25 are adjacent to each other in the direction D3.

In the direction D3, the pair of capacitance portions C2 configured by the internal electrodes 31, 32 and the internal electrode 14 and the pair of capacitance portions C3 configured by the internal electrodes 32, 33 and the internal electrode 25 are disposed between the other pair of capacitance portions C3 configured by the internal electrodes 30, 31 and the internal electrode 24 and the other pair of capacitance portions C2 configured by the internal electrodes 33, 34 and the internal electrode 15.

As illustrated in FIG. 3, the plurality of internal electrodes 6 are arranged to be rotationally symmetrical as viewed from the direction D2. In the example illustrated in FIG. 3, in the multilayer capacitor C, the main surface 4e is positioned at the top and the main surface 4f is positioned at the bottom, but even when the multilayer capacitor C is rotated 180 degrees so that the main surface 4e is positioned at the bottom and the main surface 4f is positioned at the top, the arrangement of the plurality of internal electrodes 1 and the plurality of internal electrodes 2 is exchanged and the arrangement of the plurality of internal electrodes 3 does not change, so the configuration of the plurality of internal electrodes 6 viewed from the direction D2 does not change.

The plurality of internal electrodes 1 and the plurality of internal electrodes 2 are arranged to form a capacitance c1. In the present embodiment, the capacitance c1 includes a capacitance formed by the plurality of capacitance portions C1. A rated capacitance between the external electrode 51 and the external electrode 52 includes the capacitance c1.

The plurality of internal electrodes 1 and the plurality of internal electrodes 3 are arranged to form a capacitance c2. In the present embodiment, the capacitance c2 includes a capacitance formed by the plurality of capacitance portions C2. A rated capacitance between the external electrode 51 and the external electrode 53 includes the capacitance c2.

The plurality of internal electrodes 2 and the plurality of internal electrodes 3 are arranged to form a capacitance c3. In the present embodiment, the capacitance c3 includes a capacitance formed by the plurality of capacitance portions C3. A rated capacitance between the external electrode 52 and the external electrode 53 includes the capacitance c3.

For example, the capacitance c1 includes a first capacitance, the capacitance c2 includes a second capacitance, and the capacitance c3 includes a third capacitance. The capacitance c1 is larger than both the capacitance c2 and the capacitance c3. The capacitance c2 and the capacitance c3 may be equal.

As illustrated in FIG. 4, the plurality of internal electrodes 1 each include a connection end 1a, an end 1b, an end 1c, and an end 1d. The connection end 1a is connected to the external electrode 51. For example, the connection end 1a includes a first connection end. The end 1b opposes the end surface 4b. The end 1c opposes the side surface 4c. The end 1d opposes the side surface 4d. In the present embodiment, the plurality of internal electrodes 1 each include a pair of ends 1aa. The end 1aa opposes the end surface 4a. In the direction D2, the connection end 1a is located between the pair of ends 1aa. The connection end 1a connects a region between the pair of ends 1aa and the external electrode 51.

The internal electrode 1 includes a width d1 that is a maximum width in the direction D2. For example, the width d1 includes a first width. In the present embodiment, a maximum width d1a of the connection end 1a in the direction D2 is smaller than the width d1.

As illustrated in FIG. 5, the plurality of internal electrodes 3 each include a connection end 3c, an end 3cc, an end 3dd, an end 3a, and an end 3b. In the present embodiment, the plurality of internal electrodes 3 each include a connection end 3d. The connection end 3c is connected to the external electrode 53. For example, the connection end 3c includes a third connection end. The connection end 3d is connected to the external electrode 54. For example, the connection end 3d includes a fourth connection end. The end 3cc opposes the side surface 4c. For example, the end 3cc includes a third end. The end 3dd opposes the side surface 4d. For example, the end 3dd includes a fourth end. In the present embodiment, the plurality of internal electrodes 3 each include a pair of ends 3cc and a pair of ends 3dd. In the direction D1, the connection end 3c is located between the pair of ends 3cc. The connection end 3c connects a region between the pair of ends 3cc and the external electrode 53. In the direction D1, the connection end 3d is located between the pair of ends 3dd. The connection end 3d connects a region between the pair of ends 3dd and the external electrode 54. The end 3a opposes the end surface 4a. The end 3b opposes the end surface 4b.

The internal electrode 3 includes a width d3 and a width d4. The width d3 is a maximum width between the end 3cc and the end 3dd in the direction D2. For example, the width d3 includes a third width. The width d4 is a maximum width in the direction D1. In the present embodiment, the width d4 is a width between the end 3a and the end 3b in the direction D1. For example, the width d4 includes a fourth width. A maximum width d3c of the connection end 3c in the direction D1 is smaller than the width d4. A maximum width d3d of the connection end 3d in the direction D1 is smaller than the width d4.

As illustrated in FIG. 6, the plurality of internal electrodes 2 each include a connection end 2b, an end 2a, an end 2c, and an end 2d. The connection end 2b is connected to the external electrode 52. For example, the connection end 2b includes a second connection end. The end 2a opposes the end surface 4a. The end 2c opposes the side surface 4c. The end 2d opposes the side surface 4d. In the present embodiment, the plurality of internal electrodes 2 each include a pair of ends 2bb. The end 2bb opposes the end surface 4b. In the direction D2, the connection end 2b is located between the pair of ends 2bb. The connection end 2b connects a region between the pair of ends 2bb and the external electrode 52.

The internal electrode 2 includes a width d2 that is a maximum width in the direction D2. For example, the width d2 includes a second width. In the present embodiment, a maximum width d2b of the connection end 2b in the direction D2 is smaller than the width d2.

The internal electrode 3 includes at least one of the width d3 smaller than both the width d1 and the width d2, and the width d4 smaller than a distance d5 in the direction D1 between the end 1b and the end 2a. In the present embodiment, the internal electrode 3 includes both the width d3 smaller than both the width d1 and the width d2, and the width d4 smaller than the distance d5 in the direction D1 between the end 1b and the end 2a. The distance d5 is illustrated in FIG. 2. The distance d5 may be a maximum distance in the direction D1 between the end 1b and the end 2a. The distance d5 may be a distance between the end 1b of the internal electrode 1 adjacent to the internal electrode 3 and the end 2a of the internal electrode 2 adjacent to the internal electrode 3.

In the present embodiment, one internal electrode 3 located between one internal electrode 1 and one internal electrode 2 has the end 3cc and the end 3dd which define the width d3 and are located within a region between the one internal electrode 1 and the one internal electrode 2 in the direction D3. The internal electrode 1 and the internal electrode 2 may be adjacent to the internal electrode 3. As viewed from the direction D3, the end 3cc and the end 3dd that define the width d3 of the internal electrode 3 located between the internal electrode 1 and the internal electrode 2 are included in a portion where the internal electrode 1 and the internal electrode 2 overlap.

For example, the end 3cc and the end 3dd of the internal electrode 31 are located within a region between the internal electrode 24 and the internal electrode 14 in the direction D3. For example, the end 3cc and the end 3dd of the internal electrode 32 are located within a region between the internal electrode 14 and the internal electrode 25 in the direction D3. For example, the end 3cc and the end 3dd of the internal electrode 33 are located within a region between the internal electrode 25 and the internal electrode 15 in the direction D3.

The end 3cc and the end 3dd of the internal electrode 30 may be located within a region between the internal electrode 13 and the internal electrode 24 in the direction D3. The end 3cc and the end 3dd of the internal electrode 34 may be located within a region between the internal electrode 15 and the internal electrode 26 in the direction D3.

In the present embodiment, one internal electrode 3 located between one internal electrode 1 and one internal electrode 2 has both ends 3a, 3b in the direction D1 which define the width d4 and are located within a region between the one internal electrode 1 and the one internal electrode 2 in the direction D3. The ends 3a, 3b are both ends in the direction D1. The internal electrode 1 and the internal electrode 2 may be adjacent to the internal electrode 3. As viewed from the direction D3, the end 3a and the end 3b of the internal electrode 3 located between the internal electrode 1 and the internal electrode 2 are included in a portion where the internal electrode 1 and the internal electrode 2 overlap.

For example, the end 3a and the end 3b of the internal electrode 31 are located within a region between the internal electrode 24 and the internal electrode 14 in the direction D3. For example, the end 3a and the end 3b of the internal electrode 32 are located within a region between the internal electrode 14 and the internal electrode 25 in the direction D3. For example, the end 3a and the end 3b of the internal electrode 33 are located within a region between the internal electrode 25 and the internal electrode 15 in the direction D3. The end 3a and the end 3b of the internal electrode 30 may be located within a region between the internal electrode 13 and the internal electrode 24 in the direction D3. The end 3a and the end 3b of the internal electrode 34 may be located within a region between the internal electrode 15 and the internal electrode 26 in the direction D3.

As illustrated in FIG. 3, a minimum distance in the direction D3 between an internal electrode 1 and an internal electrode 2 adjacent to each other among the plurality of internal electrodes 1 and the plurality of internal electrodes 2 is indicated as a minimum distance d12. A distance in the direction D3 between an internal electrode 1 and an internal electrode 2 adjacent to each other among the plurality of internal electrodes 1 and the plurality of internal electrodes 2 may be equal to the minimum distance d12.

A minimum distance in the direction D3 between an internal electrode 1 and an internal electrode 3 adjacent to each other among the plurality of internal electrodes 1 and the plurality of internal electrodes 3 is indicated as a minimum distance d13. A distance in the direction D3 between an internal electrode 1 and an internal electrode 3 adjacent to each other among the plurality of internal electrodes 1 and the plurality of internal electrodes 3 may be equal to the minimum distance d13.

A minimum distance in the direction D3 between an internal electrode 2 and an internal electrode 3 adjacent to each other among the plurality of internal electrodes 2 and the plurality of internal electrodes 3 is indicated as a minimum distance d23. A distance in the direction D3 between an internal electrode 2 and an internal electrode 3 adjacent to each other among the plurality of internal electrodes 2 and the plurality of internal electrodes 3 may be equal to the minimum distance d23.

In the present embodiment, the minimum distance d12 between the internal electrode 1 and the internal electrode 2 is smaller than the minimum distance d13 between the internal electrode 1 and the internal electrode 3, and is smaller than the minimum distance d23 between the internal electrode 2 and the internal electrode 3. For example, the minimum distance d12 may be not more than half of the minimum distance d13 and not more than half of the minimum distance d23.

In the present embodiment, each internal electrode 1 includes an electrode area S1 defined by the distance d5 in the direction D1 between the end 1b and the end 2a and the width d1. Each internal electrode 2 includes an electrode area S2 defined by the distance d5 in the direction D1 between the end 1b and the end 2a and the width d2. Each internal electrode 3 includes an electrode area S3 defined by the width d3 and the width d4. For example, the electrode area S1 includes a first electrode area, the electrode area S2 includes a second electrode area, and the electrode area S3 includes a third electrode area.

A ratio of the electrode area S3 to the electrode area S1 of an internal electrode 1 and an internal electrode 3 adjacent to each other among the plurality of internal electrodes 1 and the plurality of internal electrodes 3 is not less than 0.77 and not more than 0.94. In other words, in an internal electrode 1 and an internal electrode 3 adjacent to each other, a ratio of the electrode area S3 of the internal electrode 3 to the electrode area S1 of the internal electrode 1 is not less than 0.77 and not more than 0.94.

A ratio of the electrode area S3 to the electrode area S2 of an internal electrode 2 and an internal electrode 3 adjacent to each other among the plurality of internal electrodes 2 and the plurality of internal electrodes 3 is not less than 0.77 and not more than 0.94. In other words, in an internal electrode 2 and an internal electrode 3 adjacent to each other, a ratio of the electrode area S3 of the internal electrode 3 to the electrode area S2 of the internal electrode 2 is not less than 0.77 and not more than 0.94.

In the present embodiment, as viewed from the third direction D3, a ratio of the electrode area S3 of one internal electrode 3 among the plurality of third internal electrodes 3, located between one internal electrode 1 among the plurality of first internal electrodes 1 and one internal electrode 2 among the plurality of second internal electrodes 2, to an overlapping area of the one internal electrode 1 and the one internal electrode 2 is not less than 0.77 and not more than 0.94. The one internal electrode 1 and the one internal electrode 2 are adjacent to each other with the one internal electrode 3 interposed therebetween. The one internal electrode 3 is adjacent to each of the one internal electrode 1 and the one internal electrode 2. The internal electrodes 14, 31, 24, the internal electrodes 14, 32, 25, and the internal electrodes 15, 33, 25 are examples of the one internal electrode 1, the one internal electrode 3, and the one internal electrode 2.

In the present embodiment, as viewed from the third direction D3, a ratio of an area of a portion where the one internal electrode 1, the one internal electrode 3, and the one internal electrode 2 overlap to an overlapping area of the one internal electrode 1 and the one internal electrode 2 is not less than 0.77 and not more than 0.94.

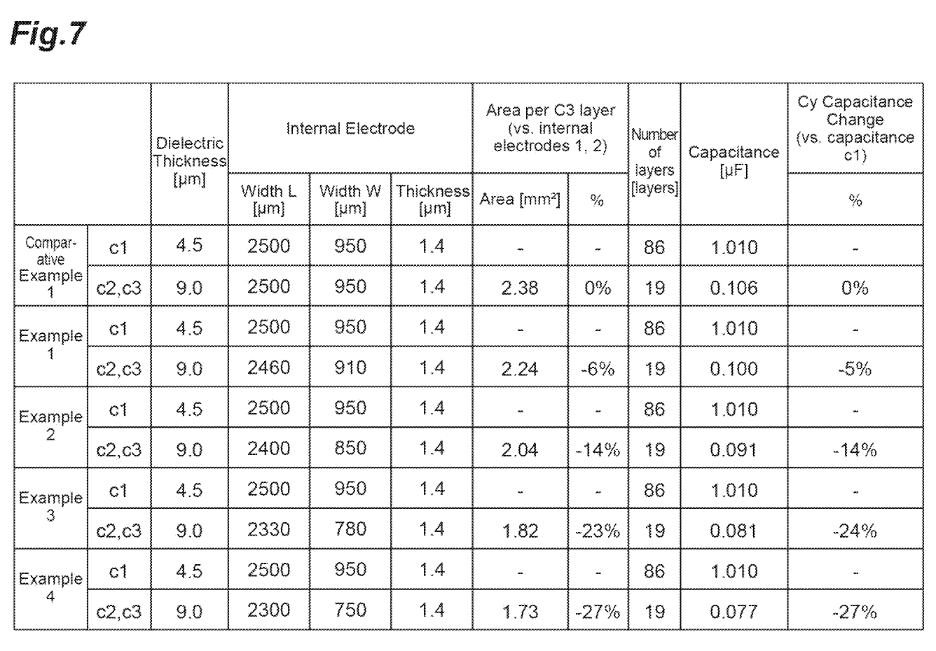

Hereinafter, experimental results illustrating a relationship among the widths d1, d2, d3, d4, the distance d5, the electrode areas S1, S2, S3, and the capacitance in the multilayer capacitor C will be described with reference to FIG. 7. FIG. 7 is a table illustrating a relationship between a ratio of the electrode area S3 to the electrode areas S1 and S2 and the rated capacitance. The inventors examined five multilayer capacitors shown as Comparative Example 1, Example 1, Example 2, Example 3, and Example 4 as samples.

### Comparative Example 1

Internal electrodes 1, 2

Width L: 2500 μm

Width W: 950 μm

Thickness: 1.4 μm

Minimum distance d12: 4.5 μm

Electrode areas S1, S2: 2.38 mm²

Number of layers: 86 layers

Capacitance c1: 1.010 μF

Internal electrode 3:

Width L: 2500 μm

Width W: 950 μm

Thickness: 1.4 μm

Minimum distances d13,d23: 9.0 μm

Electrode area S3: 2.38 mm²

Number of layers: 19 layers

Capacitances c2, c3: 0.106 μF

### Example 1

Internal electrodes 1, 2

Width L: 2500 μm

Width W: 950 μm

Thickness: 1.4 μm

Minimum distance d12: 4.5 μm

Electrode areas S1, S2: 2.38mm²

Number of layers: 86 layers

Capacitance c1: 1.010 μF

Internal electrode 3

Width L: 2460 μm

Width W: 910 μm

Thickness: 1.4 μm

Minimum distances d13, d23: 9.0 μm

Electrode area S3: 2.24mm² (-6% compared to electrode areas S1, S2)

Number of layers: 19 layers

Capacitances c2, c3: 0.100 μF (-5% compared to capacitance c1)

### Example 2

Internal electrodes 1, 2

Width L: 2500 μm

Width W: 950 μm

Thickness: 1.4 μm

Minimum distance d12: 4.5 μm

Electrode areas S1, S2: 2.38 mm²

Number of layers: 86 layers

Capacitance c1: 1.010 μF

Internal electrode 3

Width L: 2400 μm

Width W: 850 μm

Thickness: 1.4 μm

Minimum distances d13, d23: 9.0 μm

Electrode area S3: 2.04 mm² (-14% compared to electrode areas S1, S2)

Number of layers: 19 layers

Capacitances c2, c3: 0.091 μF (-14% compared to capacitance c1)

### Example 3

Internal electrodes 1, 2

Width L: 2500 μm

Width W: 950 μm

Thickness: 1.4 μm

Minimum distance d12: 4.5 μm

Electrode areas S1, S2: 2.38 mm²

Number of layers: 86 layers

Capacitance c1: 1.010 μF

Internal electrode 3

Width L: 2330 μm

Width W: 780 μm

Thickness: 1.4 μm

Minimum distances d13, d23: 9.0 μm

Electrode area S3: 1.82 mm² (-23% compared to electrode areas S1, S2)

Number of layers: 19 layers

Capacitances c2, c3: 0.081 μF (-24% compared to capacitance c1)

### Example 4

Internal electrodes 1, 2

Width L: 2500 μm

Width W: 950 μm

Thickness: 1.4 μm

Minimum distance d12: 4.5 μm

Electrode areas S1, S2: 2.38 mm²

Number of layers: 86 layers

Capacitance c1: 1.010 μF

Internal electrode 3:

Width L: 2300 μm

Width W: 750 μm

Thickness: 1.4 μm

Minimum distances d13, d23: 9.0 μm

Electrode area S3: 1.73 mm² (-27% compared to electrode areas S1, S2)

Number of layers: 19 layers

Capacitances c2, c3: 0.077 μF (-27% compared to capacitance c1)

In the internal electrodes 1 and 2 of Comparative Example 1 and Examples 1 to 4, the width L and the width W correspond to the distance d5 and the width d1 or the width d2, respectively.

In the internal electrode 3 of Comparative Example 1 and Examples 1 to 4, the width L and the width W correspond to the width d4 and the width d3, respectively.

In Comparative Example 1 and Examples 1 to 4, each distance between the internal electrode 1 and the internal electrode 2 adjacent to each other is equal to the minimum distance d12. Each distance between the internal electrode 1 and the internal electrode 3 adjacent to each other is equal to the minimum distance d13. Each distance between the internal electrode 2 and the internal electrode 3 adjacent to each other is equal to the minimum distance d23. The minimum distance d13 and the minimum distance d23 are equal.

Each capacitance of Comparative Example 1 and Examples 1 to 4 indicates a rated capacitance. Each capacitance may be obtained by simulation or may be measured by an LCR meter.

Comparative Example 1 is a conventional multilayer capacitor in which the internal electrode 3 includes the width d3 equal to the widths d1 and d2, and the width d4 equal to the distance d5.

Examples 1 to 4 are multilayer capacitors according to embodiments of the present disclosure in which the internal electrode 3 includes the width d3 smaller than the widths d1 and d2, and the width d4 smaller than the distance d5.

Referring to the experimental results of Comparative Example 1 and Examples 1 to 4, it was confirmed that the capacitances c2 and c3 decrease in comparison with the capacitance c1 in correlation with the electrode area S3.

According to Example 1, it was confirmed that when the electrode area S3 is -6% with respect to the electrode areas S1 and S2, the capacitances c2 and c3 are -5% with respect to the capacitance c1. According to Example 2, it was confirmed that when the electrode area S3 is -14% with respect to the electrode areas S1 and S2, the capacitances c2 and c3 are -14% with respect to the capacitance c1. According to Example 3, it was confirmed that when the electrode area S3 is -23% with respect to the electrode areas S1 and S2, the capacitances c2 and c3 are -24% with respect to the capacitance c1. According to Example 4, it was confirmed that when the electrode area S3 is -27% with respect to the electrode areas S1 and S2, the capacitances c2 and c3 are -27% with respect to the capacitance c1.

As described above, the plurality of internal electrodes 3 form the capacitance c2 with the plurality of internal electrodes 1 and form the capacitance c3 with the plurality of internal electrodes 2. Each of the capacitance c2 and the capacitance c3 is relatively smaller than the capacitance c1 between the plurality of internal electrodes 1 and the plurality of internal electrodes 2. Each internal electrode 3 includes both the width d3, which is smaller than both the width d1 and the width d2, and the width d4, which is smaller than the distance d5 in the direction D1 between the end 1b and the end 2a.

Since the internal electrode 3 includes the width d3 smaller than both the width d1 and the width d2, even if relative positions of the plurality of internal electrodes 3, the plurality of internal electrodes 1, and the plurality of internal electrodes 2 vary in the direction D2, the capacitance c2 or the capacitance c3 is unlikely to vary as long as the variation is within a range that does not alter an opposing area between the internal electrode 3 and the internal electrode 1 or between the internal electrode 3 and the internal electrode 2.

Since the internal electrode 3 includes the width d4 smaller than the distance in the direction D1 between the end 1b and the end 2a, even if relative positions of the plurality of internal electrodes 3, the plurality of internal electrodes 1, and the plurality of internal electrodes 2 vary in the direction D1, the capacitance c2 or the capacitance c3 is unlikely to vary as long as the variation is within a range that does not alter an opposing area between the internal electrode 3 and the internal electrode 1 or between the internal electrode 3 and the internal electrode 2.

Therefore, the one aspect can accommodate a wider range of variations in the relative position of the plurality of internal electrodes 6 in both the direction D1 and the direction D2.

The minimum distance d12 in the direction D3 between an internal electrode 1 and an internal electrode 2 adjacent to each other among the plurality of internal electrodes 1 and the plurality of internal electrodes 2 is smaller than the minimum distance d13 in the direction D3 between an internal electrode 1 and an internal electrode 3 adjacent to each other among the plurality of internal electrodes 1 and the plurality of internal electrodes 3, and is smaller than the minimum distance d23 in the direction D3 between an internal electrode 2 and an internal electrode 3 adjacent to each other among the plurality of internal electrodes 2 and the plurality of internal electrodes 3.

In a configuration in which the minimum distance d12 between the internal electrode 1 and the internal electrode 2 is smaller than the minimum distance d13 between the internal electrode 1 and the internal electrode 3 and the minimum distance d23 between the internal electrode 2 and the internal electrode 3, the capacitance c2 between the plurality of internal electrodes 1 and the plurality of internal electrodes 3 and the capacitance c3 between the plurality of internal electrodes 2 and the plurality of internal electrodes 3 tend to be smaller than the capacitance c1 between the plurality of internal electrodes 1 and the plurality of internal electrodes 2. When the capacitance c2 or the capacitance c3 is smaller, an influence on the capacitance c2 or the capacitance c3 due to variation in relative positions of the plurality of internal electrodes 6 is large. Therefore, by accommodating a wider range of variations in the relative position of the plurality of internal electrodes 6, variation in the capacitance c2 or the capacitance c3 is further reduced.

The plurality of external electrodes 5 further include a fourth external electrode 54 disposed on the other side surface 4d of the pair of side surfaces 4c and 4d, and each internal electrode 3 further includes a fourth connection end 3d connected to the fourth external electrode 54.

Since the fourth external electrode 54 connected to each internal electrode 3 is also disposed on the side surface 4d opposing the side surface 4c, the multilayer capacitor C can be similarly mounted even when rotated 180 degrees around the direction D3. Therefore, a degree of freedom in arrangement of the multilayer capacitor C in an electronic device on which the multilayer capacitor C is mounted is improved.

The number of the plurality of internal electrodes 3 is smaller than the number of the plurality of internal electrodes 1 and is smaller than the number of the plurality of internal electrodes 2.

In a configuration in which the number of the plurality of internal electrodes 3 is smaller than the number of the plurality of internal electrodes 1 and is smaller than the number of the plurality of internal electrodes 2, the capacitance c2 between the plurality of internal electrodes 1 and the plurality of internal electrodes 3 and the capacitance c3 between the plurality of internal electrodes 2 and the plurality of internal electrodes 3 tend to be smaller than the capacitance c1 between the plurality of internal electrodes 1 and the plurality of internal electrodes 2. When the capacitance c2 or the capacitance c3 is smaller, an influence on the capacitance c2 or the capacitance c3 due to variation in relative positions of the plurality of internal electrodes 6 is large. Therefore, by accommodating a wider range of variations in the relative position of the plurality of internal electrodes 6, variation in the capacitance c2 or the capacitance c3 is further reduced.

The internal electrodes 1 and the internal electrodes 2 adjacent to each other among the plurality of internal electrodes 1 and the plurality of internal electrodes 2 constitute the plurality of capacitance portions C1. The internal electrodes 1 and the internal electrodes 3 adjacent to each other among the plurality of internal electrodes 1 and the plurality of internal electrodes 3 constitute the plurality of capacitance portions C2. The internal electrodes 2 and the internal electrodes 3 adjacent to each other among the plurality of internal electrodes 2 and the plurality of internal electrodes 3 constitute the plurality of capacitance portions C3. In the direction D3, the plurality of capacitance portions C2 and the plurality of capacitance portions C3 are disposed between the plurality of capacitance portions C1.

In a configuration in which the plurality of capacitance portions C2 and the plurality of capacitance portions C3 are disposed between the plurality of capacitance portions C1 in the direction D3, the internal electrodes 1 and 2 are positioned between the internal electrode 3 and the electronic device regardless of which of the main surface 4e or the main surface 4f opposes the electronic device as a mounting surface. As a result, since a capacitance is unlikely to be formed between the internal electrode 3 and the electronic device, variation in the capacitance c2 or the capacitance c3 is further reduced.

The element body 4 includes the main surface 4e and the main surface 4f opposing each other in the direction D3. At least one capacitance portion C10 closest to the main surface 4e among the plurality of capacitance portions C1 is closer to the main surface 4e than the plurality of capacitance portions C2 and the plurality of capacitance portions C3. At least one capacitance portion C11 closest to the main surface 4f among the plurality of capacitance portions C1 is closer to the main surface 4f than the plurality of capacitance portions C2 and the plurality of capacitance portions C3. The plurality of capacitance portions C2 and the plurality of capacitance portions C3 are disposed between the at least one capacitance portion C10 and the at least one capacitance portion C11. In a configuration in which the plurality of capacitance portions C2 and the plurality of capacitance portions C3 are disposed between the at least one capacitance portion C10 and the at least one capacitance portion C11, a distance between the internal electrode 3 and the electronic device is unlikely to change regardless of which of the main surface 4e or the main surface 4f opposes the electronic device as a mounting surface. As a result, since a capacitance formed between the internal electrode 3 and the electronic device is also unlikely to change, variation in the capacitance c2 or the capacitance c3 is further reduced.

The plurality of capacitance portions C2 include a pair of capacitance portions C2 adjacent to each other in the direction D3. The plurality of capacitance portions C3 include a pair of capacitance portions C3 adjacent to each other in the direction D3. The pair of capacitance portions C2 and the pair of capacitance portions C3 are adjacent to each other in the direction D3.

In the pair of capacitance portions C2 and the pair of capacitance portions C3 adjacent to each other, the internal electrode 3 is disposed between the internal electrode 1 and the internal electrode 2. The internal electrode 1 is connected to the external electrode 51, and the internal electrode 3 is connected to the external electrode 53. Therefore, an arrangement of the internal electrodes 1 and 2 in the pair of capacitance portions C2 and the pair of capacitance portions C3 adjacent to each other has a rotationally symmetrical relationship as viewed from the direction D2. Regardless of which of the main surface 4e or the main surface 4f opposes the electronic device as a mounting surface, since the internal electrode 1 and the internal electrode 2 have a rotationally symmetrical relationship as viewed from the direction D2, a capacitance formed between the internal electrodes 1, 2, 3 and the electronic device is unlikely to change.

The plurality of capacitance portions C2 include another pair of capacitance portions C2 adjacent to each other in the direction D3. The plurality of capacitance portions C3 include another pair of capacitance portions C3 adjacent to each other in the direction D3. In the direction D3, the pair of capacitance portions C2 and the pair of capacitance portions C3 that are adjacent to each other are disposed between the other pair of capacitance portions C2 and the other pair of capacitance portions C3.

As described above, the arrangement of the internal electrodes 1 and 2 has a rotationally symmetrical relationship as viewed from the direction D2. The other pair of capacitance portions C2 and the other pair of capacitance portions C3 are closer to the main surfaces 4e and 4f than the pair of capacitance portions C2 and the pair of capacitance portions C3 adjacent to each other. Even in the other pair of capacitance portions C2 and the other pair of capacitance portions C3 close to the main surfaces 4e and 4f, the arrangement of the internal electrodes 1 and 2 has a rotationally symmetrical relationship as viewed from the direction D2. Therefore, regardless of which of the main surface 4e or the main surface 4f opposes the electronic device as a mounting surface, a capacitance formed between the internal electrodes 1, 2, 3 and the electronic device is further unlikely to change.

The plurality of internal electrodes 6 are arranged to be rotationally symmetrical as viewed from the direction D2.

In a configuration in which the plurality of internal electrodes 6 are arranged to be rotationally symmetrical as viewed from the direction D2, a positional relationship between the plurality of internal electrodes 6 and the electronic device is unlikely to change regardless of which of the main surface 4e or the main surface 4f opposes the electronic device as a mounting surface. As a result, since a capacitance formed between the plurality of internal electrodes 6 and the electronic device is also unlikely to change, variation in the capacitance c2 or the capacitance c3 is further reduced.

Each internal electrode 1 includes an electrode area S1 defined by the distance d5 in the direction D1 between the end 1b and the end 2a and the width d1. Each internal electrode 2 includes an electrode area S2 defined by the distance d5 in the direction D1 between the end 1b and the end 2a and the width d2. Each internal electrode 3 includes an electrode area S3 defined by the width d3 and the width d4. A ratio of the electrode area S3 to the electrode area S1 of an internal electrode 1 and an internal electrode 3 adjacent to each other among the plurality of internal electrodes 1 and the plurality of internal electrodes 3 is not less than 0.77 and not more than 0.94. A ratio of the electrode area S3 to the electrode area S2 of an internal electrode 2 and an internal electrode 3 adjacent to each other among the plurality of internal electrodes 2 and the plurality of internal electrodes 3 is not less than 0.77 and not more than 0.94.

In a configuration in which the ratio of the electrode area S3 is not less than 0.77 and not more than 0.94, a ratio of the capacitances c2 and c3 to the capacitance c1 is not less than 75% and not more than 95%. As a result, a multilayer capacitor C is provided in which variation in the capacitance c2 or the capacitance c3 is reduced, and the capacitances c2 and c3 have appropriate magnitudes.

As viewed from the third direction D3, a ratio of the electrode area S3 of one internal electrode 3 among the plurality of third internal electrodes 3, located between one internal electrode 1 among the plurality of first internal electrodes 1 and one internal electrode 2 among the plurality of second internal electrodes 2, to an overlapping area of the one internal electrode 1 and the one internal electrode 2 is not less than 0.77 and not more than 0.94.

In a configuration in which the ratio of the electrode area S3is not less than 0.77 and not more than 0.94, a ratio of the capacitances c2 and c3 to the capacitance c1 is not less than 75% and not more than 95%. As a result, a multilayer capacitor C is provided in which variation in the capacitance c2 or the capacitance c3 is reduced, and the capacitances c2 and c3 have appropriate magnitudes.

As viewed from the third direction D3, a ratio of an area of a portion where the one internal electrode 1, the one internal electrode 3, and the one internal electrode 2 overlap to an overlapping area of the one internal electrode 1 and the one internal electrode 2 is not less than 0.77 and not more than 0.94.

In a configuration in which the ratio of the area of the portion where the one internal electrode 1, the one internal electrode 3, and the one internal electrode 2 overlap is not less than 0.77 and not more than 0.94, a ratio of the capacitances c2 and c3 to the capacitance c1 is not less than 75% and not more than 95%. As a result, a multilayer capacitor C is provided in which variation in the capacitance c2 or the capacitance c3 is reduced, and the capacitances c2 and c3 have appropriate magnitudes.

A maximum width of the connection end 1a in the direction D2 is smaller than the width d1. A maximum width of the connection end 2b in the direction D2 is smaller than the width d2. A maximum width of the connection end 3c in the direction D1 is smaller than the width d4.

In a configuration in which the connection ends 1a, 2b, and 3c are smaller than the widths d1, d2, and d4, respectively, exposure of the internal electrodes 1, 2, and 3 on the surface of the element body 4 is smaller than in a configuration in which the connection ends 1a, 2b, and 3c are equal to the widths d1, d2, and d4. As a result, a possibility that a plating solution or the like for forming the external electrodes 51, 52, and 53 enters the element body 4 is reduced.

The present disclosure has been described in detail based on the embodiments. However, the present disclosure is not limited to the above embodiments. The present disclosure can be variously modified without departing from the gist thereof. It is to be understood that not all aspects, advantages and features described herein may necessarily be achieved by, or included in, any one particular example. Indeed, having described and illustrated various examples herein, it should be apparent that other examples may be modified in arrangement and detail.

The plurality of capacitance portions C2 may include a capacitance portion C2 configured by the internal electrode 13 and the internal electrode 30. The plurality of capacitance portions C3 may include a capacitance portion C3 configured by the internal electrode 26 and the internal electrode 34.

What is claimed is:

1. A multilayer capacitor comprising:
an element body including a first end surface and a second end surface opposing each other in a first direction, and a pair of side surfaces opposing each other in a second direction intersecting the first direction;
a plurality of external electrodes including a first external electrode disposed on the first end surface, a second external electrode disposed on the second end surface, and a third external electrode disposed on one of the pair of side surfaces; and
a plurality of internal electrodes arranged in the element body to oppose each other in a third direction intersecting the first direction and the second direction,
wherein the plurality of internal electrodes include:
a plurality of first internal electrodes each including a first connection end connected to the first external electrode, and a first end opposing the second end surface;
a plurality of second internal electrodes each including a second connection end connected to the second external electrode, and a second end opposing the first end surface; and
a plurality of third internal electrodes each including a third connection end connected to the third external electrode, a third end opposing the one of the pair of side surfaces, and a fourth end opposing the other of the pair of side surfaces,
each of the first internal electrodes has a first width that is a maximum width in the second direction,
each of the second internal electrodes has a second width that is a maximum width in the second direction,
each of the third internal electrodes has a third width that is a maximum width between the third end and the fourth end in the second direction, and a fourth width that is a maximum width in the first direction, each of the third internal electrodes satisfies at least one of:
a condition in which the third width is smaller than both the first width and the second width; or
a condition in which the fourth width is smaller than a distance between the first end and the second end in the first direction,
the plurality of first internal electrodes and the plurality of second internal electrodes are arranged to provide a first capacitance,
the plurality of first internal electrodes and the plurality of third internal electrodes are arranged to provide a second capacitance smaller than the first capacitance, and
the plurality of second internal electrodes and the plurality of third internal electrodes are arranged to provide a third capacitance smaller than the first capacitance.

2. The multilayer capacitor according to claim 1, wherein
each of the third internal electrodes includes the third width smaller than both the first width and the second width, and
the plurality of third internal electrodes includes one third internal electrode located between one first internal electrode of the plurality of first internal electrodes and one second internal electrode of the plurality of second internal electrodes, and the third end and fourth end defining the third width of the one third internal electrode are located in the third direction within a region between the one first internal electrode and the one second internal electrode.

3. The multilayer capacitor according to claim 1, wherein
each of the third internal electrodes includes the fourth width smaller than the distance in the first direction between the first end and the second end, and
the plurality of third internal electrodes includes one third internal electrode located between one first internal electrode of the plurality of first internal electrodes and one second internal electrode of the plurality of second internal electrodes, and both ends in the first direction defining the fourth width of the one third internal electrode are located in the third direction within a region between the one first internal electrode and the one second internal electrode.

4. The multilayer capacitor according to claim 1, wherein
a minimum distance in the third direction between a pair of a first internal electrode and a second internal electrode adjacent to each other among the plurality of first internal electrodes and the plurality of second internal electrodes is smaller than a minimum distance in the third direction between a pair of a first internal electrode and a third internal electrode adjacent to each other among the plurality of first internal electrodes and the plurality of third internal electrodes, and is smaller than a minimum distance in the third direction between a pair of a second internal electrode and a third internal electrode adjacent to each other among the plurality of second internal electrodes and the plurality of third internal electrodes.

5. The multilayer capacitor according to claim 1, wherein
the plurality of external electrodes further comprise a fourth external electrode disposed on the other of the pair of side surfaces, and
each of the third internal electrodes further includes a fourth connection end connected to the fourth external electrode.

6. The multilayer capacitor according to claim 1, wherein
a number of the plurality of third internal electrodes is smaller than a number of the plurality of first internal electrodes and is smaller than a number of the plurality of second internal electrodes.

7. The multilayer capacitor according to claim 1, wherein
the first internal electrodes and the second internal electrodes adjacent to each other among the plurality of first internal electrodes and the plurality of second internal electrodes are arranged to provide a plurality of first capacitance portions,
the first internal electrodes and the third internal electrodes adjacent to each other among the plurality of first internal electrodes and the plurality of third internal electrodes are arranged to provide a plurality of second capacitance portions,
the second internal electrodes and the third internal electrodes adjacent to each other among the plurality of second internal electrodes and the plurality of third internal electrodes are arranged to provide a plurality of third capacitance portions, and
in the third direction, the plurality of second capacitance portions and the plurality of third capacitance portions are disposed between the plurality of first capacitance portions.

8. The multilayer capacitor according to claim 7, wherein
the element body includes a first main surface and a second main surface opposing each other in the third direction,
at least one first capacitance portion closest to the first main surface among the plurality of first capacitance portions is closer to the first main surface than the plurality of second capacitance portions and the plurality of third capacitance portions are to the first main surface, and
at least one other first capacitance portion closest to the second main surface among the plurality of first capacitance portions is closer to the second main surface than the plurality of second capacitance portions and the plurality of third capacitance portions are to the second main surface.

9. The multilayer capacitor according to claim 7, wherein
the plurality of second capacitance portions include a pair of second capacitance portions adjacent to each other in the third direction,
the plurality of third capacitance portions include a pair of third capacitance portions adjacent to each other in the third direction, and
the pair of second capacitance portions and the pair of third capacitance portions are adjacent to each other in the third direction.

10. The multilayer capacitor according to claim 9, wherein
the plurality of second capacitance portions include another pair of second capacitance portions adjacent to each other in the third direction,
the plurality of third capacitance portions include another pair of third capacitance portions adjacent to each other in the third direction, and
in the third direction, the pair of second capacitance portions and the pair of third capacitance portions that are adjacent to each other are disposed between the other pair of second capacitance portions and the other pair of third capacitance portions.

11. The multilayer capacitor according to claim 1, wherein
the plurality of internal electrodes are arranged to be rotationally symmetrical as viewed from the second direction.

12. The multilayer capacitor according to claim 1, wherein
each of the first internal electrodes includes a first electrode area defined by the distance in the first direction between the first end and the second end and the first width,
each of the second internal electrodes includes a second electrode area defined by the distance in the first direction between the first end and the second end and the second width,
each of the third internal electrodes includes a third electrode area defined by the third width and the fourth width,
a ratio of the third electrode area to the first electrode area of a first internal electrode and a third internal electrode adjacent to each other among the plurality of first internal electrodes and the plurality of third internal electrodes is not less than 0.77 and not more than 0.94, and
a ratio of the third electrode area to the second electrode area of a second internal electrode and a third internal electrode adjacent to each other among the plurality of second internal electrodes and the plurality of third internal electrodes is not less than 0.77 and not more than 0.94.

13. The multilayer capacitor according to claim 12, wherein
as viewed from the third direction, a ratio of the third electrode area of one third internal electrode among the plurality of third internal electrodes, located between one first internal electrode among the plurality of first internal electrodes and one second internal electrode among the plurality of second internal electrodes, to an overlapping area of the one first internal electrode and the one second internal electrode is not less than 0.77 and not more than 0.94.

14. The multilayer capacitor according to claim 13, wherein
as viewed from the third direction, a ratio of an area of a portion where the one first internal electrode, the one third internal electrode, and the one second internal electrode overlap to an area of a portion where the one first internal electrode and the one second internal electrode overlap is not less than 0.77 and not more than 0.94.

15. The multilayer capacitor according to claim 1, wherein
a maximum width of the first connection end in the second direction is smaller than the first width,
a maximum width of the second connection end in the second direction is smaller than the second width, and
a maximum width of the third connection end in the first direction is smaller than the fourth width.

16. A multilayer capacitor comprising:
an element body including a first end surface and a second end surface opposing each other in a first direction, and a pair of side surfaces opposing each other in a second direction intersecting the first direction;
a plurality of external electrodes including a first external electrode disposed on the first end surface, a second external electrode disposed on the second end surface, and a third external electrode disposed on one of the pair of side surfaces; and
a plurality of internal electrodes arranged in the element body to oppose each other in a third direction intersecting the first direction and the second direction,
wherein the plurality of internal electrodes include:
a plurality of first internal electrodes each including a first connection end connected to the first external electrode, and a first end opposing the second end surface;
a plurality of second internal electrodes each including a second connection end connected to the second external electrode, and a second end opposing the first end surface; and
a plurality of third internal electrodes each including a third connection end connected to the third external electrode, a third end opposing the one of the pair of side surfaces, and a fourth end opposing the other of the pair of side surfaces,
each of the first internal electrodes has a first width that is a maximum width in the second direction,
each of the second internal electrodes has a second width that is a maximum width in the second direction,
each of the third internal electrodes has a third width that is a maximum width between the third end and the fourth end in the second direction, and a fourth width that is a maximum width in the first direction, each of the third internal electrodes satisfies at least one of:
a condition in which the third width is smaller than both the first width and the second width; or
a condition in which the fourth width is smaller than a distance between the first end and the second end in the first direction,
and
a minimum distance in the third direction between a pair of a first internal electrode and a second internal electrode adjacent to each other among the plurality of first internal electrodes and the plurality of second internal electrodes is smaller than a minimum distance in the third direction between a pair of a first internal electrode and a third internal electrode adjacent to each other among the plurality of first internal electrodes and the plurality of third internal electrodes, and is smaller than a minimum distance in the third direction between a pair of a second internal electrode and a third internal electrode adjacent to each other among the plurality of second internal electrodes and the plurality of third internal electrodes.

17. The multilayer capacitor according to claim 16, wherein
each of the third internal electrodes includes the third width smaller than both the first width and the second width, and
the plurality of third internal electrodes includes one third internal electrode located between one first internal electrode of the plurality of first internal electrodes and one second internal electrode of the plurality of second internal electrodes, and the third end and fourth end defining the third width of the one third internal electrode are located in the third direction within a region between the one first internal electrode and the one second internal electrode.

18. The multilayer capacitor according to claim 16, wherein
each of the third internal electrodes includes the fourth width smaller than the distance in the first direction between the first end and the second end, and
the plurality of third internal electrodes includes one third internal electrode located between one first internal electrode of the plurality of first internal electrodes and one second internal electrode of the plurality of second internal electrodes, and both ends in the first direction defining the fourth width of the one third internal electrode are located in the third direction within a region between the one first internal electrode and the one second internal electrode.

19. A multilayer capacitor comprising:
an element body including a first end surface and a second end surface opposing each other in a first direction, and a pair of side surfaces opposing each other in a second direction intersecting the first direction;
a plurality of external electrodes including a first external electrode disposed on the first end surface, a second external electrode disposed on the second end surface, and a third external electrode disposed on one of the pair of side surfaces; and
a plurality of internal electrodes arranged in the element body to oppose each other in a third direction intersecting the first direction and the second direction,
wherein the plurality of internal electrodes include:
a plurality of first internal electrodes each including a first connection end connected to the first external electrode, and a first end opposing the second end surface;
a plurality of second internal electrodes each including a second connection end connected to the second external electrode, and a second end opposing the first end surface; and
a plurality of third internal electrodes each including a third connection end connected to the third external electrode, a third end opposing the one of the pair of side surfaces, and a fourth end opposing the other of the pair of side surfaces,
a number of the plurality of third internal electrodes is smaller than a number of the plurality of first internal electrodes and is smaller than a number of the plurality of second internal electrodes,
each of the first internal electrodes has a first width that is a maximum width in the second direction,
each of the second internal electrodes has a second width that is a maximum width in the second direction, and
each of the third internal electrodes has a third width that is a maximum width between the third end and the fourth end in the second direction, and a fourth width that is a maximum width in the first direction, each of the third internal electrodes satisfies at least one of:
a condition in which the third width is smaller than both the first width and the second width; or
a condition in which the fourth width is smaller than a distance between the first end and the second end in the first direction.

20. The multilayer capacitor according to claim 19, wherein
a minimum distance in the third direction between a pair of a first internal electrode and a second internal electrode adjacent to each other among the plurality of first internal electrodes and the plurality of second internal electrodes is smaller than a minimum distance in the third direction between a pair of a first internal electrode and a third internal electrode adjacent to each other among the plurality of first internal electrodes and the plurality of third internal electrodes, and is smaller than a minimum distance in the third direction between a pair of a second internal electrode and a third internal electrode adjacent to each other among the plurality of second internal electrodes and the plurality of third internal electrodes.
